(19) United States
(12) Patent Application Publication
(10) Pub. No.: US 2023/0034000 A1
(43) Pub. Date: Feb. 2, 2023

(54) MACHINE AND METHOD FOR PREPARING A HOT BEVERAGE

(71) Applicant: Melitta Single Portions GmbH & Co. KG, Minden (DE)

(72) Inventors: Jan PAHNKE, Minden (DE); Holger FELDMANN, Willich (DE); Kerstin FERNANDES DE CARVALHO, Bielefeld (DE)

(73) Assignee: Melitta Single Portions GmbH & Co. KG, Minden (DE)

(21) Appl. No.: 17/791,313

(22) PCT Filed: Dec. 11, 2020
(86) PCT No.: PCT/EP2020/085781

§ 371 Date: Jul. 7, 2022

(30) Foreign Application Priority Data
Jan. 17, 2020 (DE) 10 2020 101 086.9

(51) Int. Cl. A47J 31/057; A47J 31/06; A47J 31/44; A47J 31/46; A47J 31/52; A23F 5/26

(52) U.S. Cl. CPC A47J 31/0573; A47J 31/0652; A47J 31/446; A47J 31/461; A47J 31/525; A47J 31/4475; A23F 5/26

(57) ABSTRACT

A machine and method for preparing a hot beverage includes a device for producing and conveying hot water; a holding device into which a filter holder can be releasably inserted; a feed for the hot water, the feed having an outlet arranged above the filter holder in order to dispense hot water onto the filter holder from above into a receiving area which is open towards the top and comprises an extraction material; and a drive device in order to move the feed for the hot water relative to the filter holder. The filter holder has a chamber for water, the chamber being fillable via an opening, and the feed can be moved relative to the filter holder between a position substantially vertically above the opening and another position substantially vertically above the receiving area comprising the extraction material.

The present invention relates to a machine for preparing a hot beverage, comprising a device for generating and conveying hot water, a holding device into which a filter holder can be releasably inserted, a feed for the hot water having an outlet arranged above the filter holder in order to dispense the hot water onto the filter holder from above into an upwardly open receptacle containing an extraction material, and drive device in order to move the feed for the hot water relative to the filter holder, and a method for preparing a hot beverage.

EP 2 700 337 B1 discloses a coffee machine in which water can be conveyed from a water tank via a heating device and a pump to a feed in order to fill the hot water into a filter holder with a filter paper insert containing coffee grounds. Brewed coffee is then dispensed from the filter holder into a vessel. Such coffee machines have proven themselves, but the full amount of heated water is always dispensed through the feed. At the beginning of the brewing process, the cold water located behind the heating device is dispensed first. The subsequent quantity of water heated in the heating device is cooled down considerably at the beginning, as it gives off energy to the still cold pipe in the feed, so that an initial quantity of water at a low temperature is dispensed via the feed until the feed has warmed up accordingly via the heated water. This has a disadvantageous effect, at least when brewing small amounts of coffee.

Therefore, it is an object of the present invention to provide a device and method for preparing a hot beverage that allows for improved brewing of the extraction material.

This object is solved with a device having the features of claim 1 as well as a method having the features of claim 11.

In the machine according to the invention, a feed for heated water is arranged above a filter holder with an outlet, via which outlet hot water can be discharged into an upwardly open receptacle with an extraction material, wherein a drive device is provided to move the feed for the hot water relative to the filter holder, and the filter holder comprises a chamber for water which is fillable via an opening, and the feed is movable relative to the filter holder between a position substantially vertically above the opening and a further position substantially vertically above the receptacle with the extraction material. Thus, in a first step, the feed can be positioned above the opening to introduce a first amount of water into the chamber for collecting water, such that this first amount of water is used to heat the conduit of the feed without already being in contact with the extraction material. In a second step, the feed with the outlet is then positioned over the receptacle with the extraction material, so that hot water can then be dispensed onto the extraction material even at the beginning of the brewing process. This avoids the initial dispensing of initially completely unheated water and then rather cooler water due to cooling by the energy dissipated to the conduit in the feed. The arrangement of the feed vertically above the opening or receptacle may or may not be exact, for example the outgoing stream of cold or hot water may also have a horizontal component of movement, so that a horizontally slightly offset arrangement of the feed to compensate for the stream being slightly inclined to the vertical is still considered to be substantially vertically above the receptacle or opening,

Preferably, the chamber for collecting water in the filter holder has a volume of between 10 ml to 400 ml, in particular 20 ml to 80 ml. This allows a sufficient amount of water to be introduced into the chamber before the actual brewing process begins, so that the heated water can then be discharged at the receptacle with the extraction material after the conduit of the feed has been heated,

Preferably, the filter holder is designed in several parts and comprises a first part for receiving extraction material, in particular with the interposition of a filter paper insert, and a second part which surrounds the first part at least in certain areas. In this case, a chamber for collecting water is formed between the first part and the second part, which can then be emptied again by removing the filter holder and pivoting it. In a particularly advantageous design, in addition to a first opening, at least one further opening is arranged on the filter holder, which is arranged opposite with respect to the receptacle, so that the receptacle is arranged between the first opening and a second opening, which are both connected to the chamber for collecting water. As a result, the filter holder can be used equally by left-handed and right-handed users even with only one handle section, since the filter holder can also be inserted into the support rotated 180° about the vertical axis. Depending on the orientation, one or the other opening is then used to hold the first amount of water. In addition, the additional opening simplifies a defined pouring of the collected water quantity, since air can flow through the respective other opening when pouring through one opening. It is also conceivable to add further openings to the filter holder.

The first part and the second part of the filter holder can be inserted into each other in a substantially shell-shaped manner. In this case, an annular chamber can be formed between the first part and the second part, which chamber is sealed in a connecting region between the first part and the second part by at least one sealing element. The filter holder is preferably movable with the first part and the second part as a unit, wherein the second part and the first part are fixed to one another by fastening means, Screws, clamping means, latching means, a thread or a bayonet lock, and other fastening means can be used as fastening means. Furthermore, other joining techniques such as gluing or welding can also be used.

In order to avoid contamination by splashing hot water, an impact surface inclined to the horizontal is preferably provided at the opening, from which the applied hot water drains into the chamber. The inclination of the impact surface to the horizontal can, for example, lie in an angular range between 10° and 60°, in particular 30° to 55°. This allows water to flow downwards via the outlet by gravity and is then introduced essentially completely into the chamber. This also largely prevents splashing on impact and thus minimizes the risk of scalding,

For ease of handling when brewing the hot beverage, a valve for opening and closing an outlet opening can be provided on the receptacle on the underside. The valve can optionally be opened mechanically, for example by placing a pot underneath the filter holder, by inserting it in a holder and interacting with an actuating geometry, or by means of a controller by means of which the valve can be actuated. The filter holder is preferably stationary on the machine, while the feed is moved by a drive. Optionally, of course, the feed and filter holder or only the filter holder can be moved to effect relative movement between the filter holder and feed.

In a further design, a sensor is provided on the feed or the holding device by means of which it can be detected whether the filter holder is arranged on the holding device. Then, by means of the sensor, a controller can be activated which prevents hot water from being dispensed if the filter holder is not or not correctly inserted into the holding device. Such a sensor can be designed as a contact sensor, for example an electrical sensor or an optical sensor. An optical sensor can also be used to detect whether an extraction material is located in the filter holder. For improved monitoring of the brewing process, a light source can also be provided on the feed, which radiates downwards.

In the method according to the invention, first a first quantity of water is discharged at the feed into an opening at the filter holder so that the first quantity of water is introduced into a chamber for collecting the water at the filter holder, This is first cold water that may be in the system downstream of the heater, and then the water heated in the heater that has already cooled somewhat at the beginning due to the passage in the feed. After the water is introduced into the chamber, the feed is moved relative to the filter holder from a position above the opening to a position above an upwardly open receptacle containing extraction material, wherein optionally the filter holder, the feed, or the filter holder and the feed are moved. A second amount of hot water is then dispensed onto the extraction material to brew the hot beverage. This procedure allows for complete removal of any dead water, one and one rinsing, which is advantageous from a sanitary standpoint, Preheating the feed line has a beneficial effect on extraction, especially for small quantities of beverage.

Preferably, the first amount of hot water introduced into the chamber is between 1 ml to 80 ml, in particular between 5 ml and 30 mi. This allows the feed to be heated and rinsed to a certain extent via the first quantity, For the method, the filter holder can be arranged in a stationary manner when the feed is moved via a drive device.

The invention is explained in more detail below by means of an exemplary embodiment with reference to the accompanying drawings, wherein:

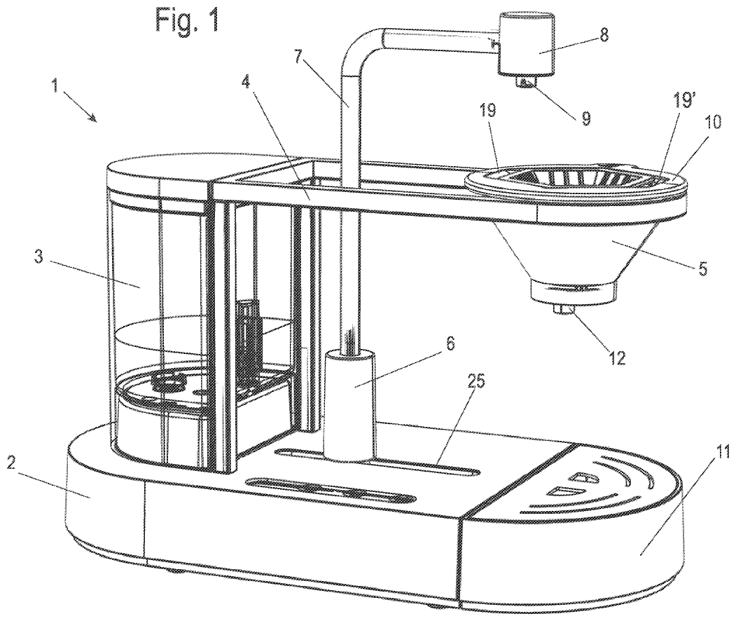

FIG. 1 shows a view of a machine according to the invention for preparing a hot beverage, and

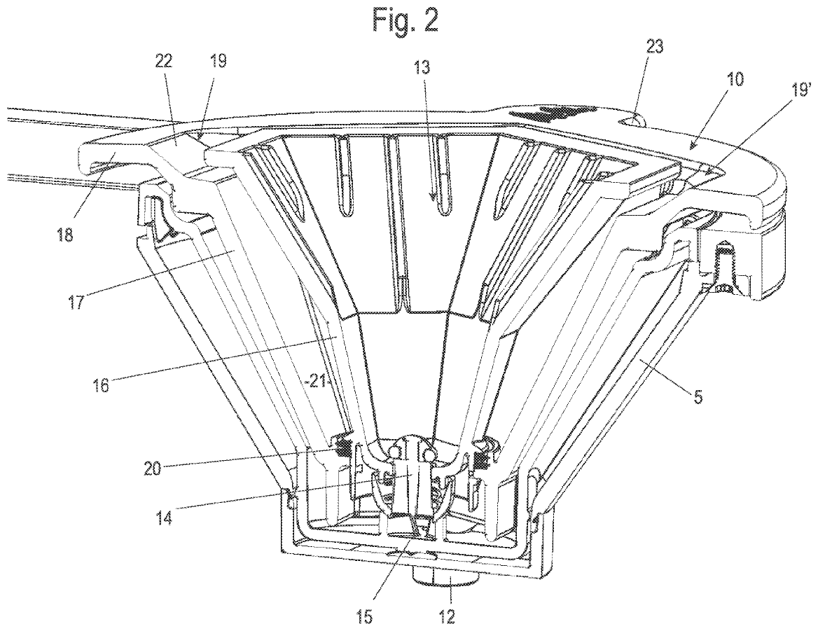

FIG. 2 shows a sectional view through the filter holder of the machine of FIG. 1,

A machine 1 for preparing a hot beverage comprises a base station 2, which has a housing in which a heating device, a pump and a controller are arranged. A removable tank 3 for fresh water is provided at the base station 2, via which water can be conveyed to the pump, the heating device and to a feed 7. The feed 7 is designed as a pipeline projecting upward from the base station 2. The feed 7 is not stationary on the housing of the base station 2, but can be moved by a drive unit. A carriage 6 is provided for this purpose, which can be moved linearly by the drive device along a guide below a housing opening 25 on the base station 2. In addition, the carriage 6 can be rotated by another drive so that the feed 7 can be rotated about a vertical axis, Other drives can also be used to move the feed 7.

The feed 7 has a vertical section and a horizontal section, with the feed 7 opening out at an outlet 9, which is arranged above a filter holder 10. A holder 8 is also provided on the feed 7 above the outlet 9, on which, for example, a light source, in particular LED light source, is provided, which can be controlled via a controller in the base station 2. In addition, an optical sensor may be provided on the holder 8 to detect whether or not a filter holder 10 is inserted on a holding device 4 of the machine 1. Optionally, such a sensor may also detect whether a filter paper insert and/or an extraction material is arranged in the filter holder 10. For example, an optical sensor with corresponding color recognition can be used for this purpose.

The machine has a fixed holding device 4 on the base station 2, on which a bowl-shaped support 5 is provided for the detachable insertion of the filter holder 10, An outlet 12 for the brewed beverage, in particular for coffee or tea, is provided on the underside of the support 5.

The filter holder 10 is shown in section in FIG. 2.

The filter holder 10 comprises an upwardly open receptacle 13 on a first part 16. A filter paper insert or another filter insert with an extraction material can be inserted into the receptacle 13. On the underside of the receptacle 13, a valve 14 is provided at a bottom by means of which a lower outlet opening at the part 16 can be opened and closed. The valve 14 is thereby pretensioned into the closed position and can optionally be opened or closed by mechanical actuation means, for example a vessel below the filter holder 10, insertion into the support 5 and interaction with an actuation geometry 15 or by a controller. When the valve 14 is open, the brewed beverage can be dispensed through the outlet 12 into a vessel,

A second part 17 is arranged around the first part 16 of the filter holder 10, which is also shell-shaped and is arranged at a distance from the first part 16, As a result, an annular or sleeve-shaped chamber 21 for collecting water is formed between the first part 16 and the second part 17. The first part 16 and the second part 17 are arranged in a sealing manner against one another in a lower region via at least one sealing element 20.

The filter holder 10 is detachably inserted into the ring- or bowl-shaped support 5 of the machine 1 and can be easily removed upwardly via a protruding handle section 23.

An upwardly facing opening 19 is formed on the filter holder 10, into which a first quantity of water can be filled, Below the opening 19, an impact surface 22 is provided which is arranged integrally with the second part 17 below a horizontal edge 18 of the filter holder 10. The impact surface 22 is inclined to the horizontal, for example at an angle between 10° and 60°, in particular 30° to 55°, in order to deflect impacting water into the chamber 21 without splashing the rim 18, other components or, in the worst case, the user with hot water.

The annular chamber 21 between the first part 16 and the second part 17 preferably has a volume between 10 ml to 400 ml, in particular 20 ml to 80 ml.

For brewing coffee, a filter paper insert with an extraction material is first inserted into the filter holder 10. The filter paper insert can optionally be designed to be open at the top or closed in order to then only effect an opening via the application of hot water, as is disclosed, for example, in DE 10 2018 101 333. The filter holder 10 can then be inserted into the holding device 4 of the machine 1.

Optionally, a sensor can then be used to detect whether the filter holder 10 is filled with extraction material or a portion pack. For this purpose, a light source on the holder 8 can illuminate the filter holder 10 accordingly in order to then perform a detection with an optical sensor, which is forwarded to a controller in the base station 2.

The machine 1 now draws water from the tank 3 and conveys this via a pump and a heating device into the feed 7, which is arranged in a first position with the outlet 9 above the opening 19. This introduces a first amount of water into the opening 19 and thus the chamber 21 for collecting water. The first amount of water may be, for example, between 5 ml and 30 ml and is sufficient to preheat and flush the feed 7.

After a first amount of water has been introduced into the chamber 21, the feed 7 is moved relative to the filter holder 10, wherein in this exemplary embodiment the filter holder 10 is stationary and the feed 7 is moved via one or more drives. Then, hot water from the feed 7 can now be applied either directly to the extraction material or to a closure device on a portion pack to begin the brewing process. Optionally, the hot water from the feed 7 can also be distributed over the extraction material according to predetermined patterns so that a more uniform extraction is possible. The feed 7 can thus also be moved while dispensing a second amount of hot water. The brewed beverage, in particular the coffee, is now dispensed at the outlet 12 into a vessel which is not shown. The vessel is placed on the cup plate of a drip tray 11. In this case, the cup plate is provided with openings so that, after removal of the vessel, drops of the brewed beverage can be collected in the drip tray 11, After brewing, the filter holder 10 can then be removed from the support 5 to both dispose of the brewed extraction material and to empty the collected water from the chamber 21.

A second opening 19 is arranged on the filter holder 10 opposite the first opening 19 with respect to the receptacle 13. This means that the filter holder 10 can also be used rotated by 180° in order to collect water in the chamber 21 via the second opening 19°.

In the illustrated exemplary embodiment, the chamber 21 is arranged in an annular shape between the first part 16 and the second part 17. Of course, it is also possible to provide the chamber 21 on only one side of the filter holder, and not to make it annular.

### LIST OF REFERENCE NUMERALS

1 Machine

2 Base station

3 Tank

4 Holding device

5 Support

6 Carriage

7 Feed

8 Holder

9 Outlet

10 Filter holder

11 Drip tray

12 Outlet

13 Receptacle

14 Valve

15 Actuation geometry

16 First part

17 Second part

18 Edge

19 Opening

19′ Opening

20 Sealing element

21 Chamber

22 impact surface

23 Handle section

25 Housing opening

1. A machine (1) for the preparation of a hot beverage, comprising:
a device configured for the production and delivery of hot water;
a holding device (4) into which a filter holder (10) can be detachably inserted;
a feed (7) for the hot water having an outlet (9) arranged above the filter holder (10), the feed being configured for discharging the hot water from above the filter holder (10) into an upwardly open receptacle (13) containing an extraction material, and
a drive device configured to move the feed (7) for the hot water relative to the filter holder (10),
wherein the filter holder (10) comprises a chamber (21) for collecting water which is fillable via an opening (19, 19′) and the feed (7) is movable relative to the filter holder (10) between a position substantially vertically above the opening (19) and a further position substantially vertically above the receptacle (13) containing the extraction material.

2. The machine according to claim 1, wherein the chamber (21) for collecting water in the filter holder (10) has a volume between 10 ml to 400 ml.

3. The machine according to claim 1, wherein the filter holder (10) is formed in several parts comprising a first part and second part, and the first part (16) forms the receptacle for the extraction material and the first part (16) is surrounded by the second part (17) at least in regions, and the chamber (21) for collecting water is formed between the first part (16) and the second part (17).

4. The machine according to claim 3, wherein the chamber (21) is of annular design and a sealing element (20) is arranged between the first part (16) and the second part (17).

5. The machine according to claim 3, wherein the second part (17) is fixed to the first part (16) by fastening means.

6. The machine according to claim 1, wherein an impact surface (22) inclined to the horizontal is provided at the opening (19, 19′), from which the applied hot water drains into the chamber (21).

7. The machine according to claim 1, wherein the opening on the filter holder (10) comprises a first opening and a second opening and wherein the receptacle (13) is arranged between the first opening (19) and the second opening (19′) connected to the chamber (21) for collecting water.

8. The machine according to one of the claim 1, wherein a valve (14) for opening or closing an outlet opening is provided on the receptacle (13) on an underside.

9. The machine according to claim 1, wherein a sensor is provided on the feed (7) or the holding device (4), wherein the sensor is configured for detecting whether the filter holder (10) is arranged on the holding device (4).

10. The machine according to claim 1, wherein a downwardly radiating light source is provided at the feed (7).

11. A method for preparing a hot beverage, comprising the steps of:
heating water and conveying the heated water to a feed (7);
dispensing a first amount of water at the feed (7) into an opening (19, 19′) on a filter holder (10) from which the first amount of water is directed into a chamber (21) for collecting the water;
moving the feed (7) relative to the filter holder (10) to move the feed (7) from a position above the opening (19, 19′) to a position above an upwardly open receptacle (13) containing an extraction material, and
dispensing a second amount of hot water onto the extraction material in the filter holder (10) to brew the hot beverage.

12. Method The method according to claim 11, wherein the first amount of hot water is between 1 ml to 80 ml.

13. The method according to claim 11, wherein the filter holder (10) is arranged stationary and the feed (7) is moved via a drive device.
